(19) United States
(12) Patent Application Publication
(10) Pub. No.: US 2002/0098116 A1
(43) Pub. Date: Jul. 25, 2002

(54) Biochemical analysis system, and biochemical analysis element cartridge

(75) Inventors: Fumio Sugaya, Kanagawa-ken (JP); Akihiro Komatsu, Kanagawa-ken (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/011,769

(22) Filed: Dec. 11, 2001

(30) Foreign Application Priority Data
Dec. 13, 2000 (JP) 378520/2000
Dec. 13, 2000 (JP) 378522/2000

(51) Int. Cl. G01N 35/00

(52) U.S. Cl. 422/64; 422/100

(57) ABSTRACT

A biochemical analysis system includes a circular sample tray in which a sample and a dry analysis element suitable for analyzing the sample are contained, a spotting nozzle unit which sucks the sample in the sample tray and spots the sample onto the dry analysis element, and an incubator which keeps the dry analysis element spotted with the sample at a constant temperature. A plurality of sample cartridges each of which is a section of the sample tray in plan are removably mounted on the sample tray, and each of the sample cartridges is provided with a holding portion for holding a sample container containing a sample and a dry analysis element suitable for the item of measurement of the sample.

### BACKGROUND OF THE INVENTION

1. Field of the Invention

This invention relates to a biochemical analysis system in which a sample such as blood or urine is spotted onto a colorimetric dry analysis element, an electrolytic dry analysis element or the like and the concentration, the ion activity and the like of a specific biochemical component contained in the sample are detected. This invention further relates to a dry analysis element cartridge for such a biochemical analysis system.

2. Description of the Related Art

Recently, there has been put into practice a colorimetric dry (dry-to-the touch) analysis element with which the content of a specific biochemical component or a specific solid component contained in a sample liquid can be quantitatively analyzed by simply spotting a droplet of the sample liquid. Further, there has been put into practice an electrolytic dry analysis element with which the activity of a specific ion contained in a sample liquid can be determined by simply spotting a droplet of the sample liquid. Since being capable of analyzing samples easily and quickly, the biochemical analysis systems using such dry analysis elements are suitably used in medical institutions, laboratories and the like.

When quantitatively analyzing the chemical components or the like contained in a sample liquid using such a colorimetric dry analysis element, a droplet of the sample liquid is spotted on the analysis element, and the analysis element is held at a constant temperature for a predetermined time in an incubator so that a coloring reaction (pigment forming reaction) occurs, and the optical density of the color formed by the coloring reaction is optically measured. That is, measuring light containing a wavelength which is pre-selected according to the combination of the component to be analyzed and the reagent contained in the analysis element is projected onto the analysis element and the optical density of the analysis element is measured. Then the concentration of the component to be analyzed is determined on the basis of the optical density according to a calibration curve representing the relation between the concentration of the specific biochemical component and the optical density.

In a potential difference measuring method using the electrolytic dry analysis element, the activity of a specific ion contained in a sample liquid spotted on an ion selective electrode pair of a dry analysis element is measured in a potentiometric way instead of measuring the optical density.

In either of colorimetry or potentiometry, the sample liquid is contained in a sample container (e.g., a blood-collecting tube) and set to the analysis system with dry analysis elements supplied to the system, and the sample liquid is spotted on the dry analysis element positioned in a spotting position by a spotting nozzle unit which is movable from the sample container in a predetermined direction. There have been proposed various methods of supplying the dry analysis elements and other various consumables such as nozzle tips, mixing cups for dilution, diluent liquid containers, reference liquid containers and the like.

For example, in a biochemical analysis system disclosed in U.S. Pat. No. 4,287,155 (will be referred to as “the first biochemical analysis system”), the dry analysis elements are contained in cartridges kind by kind while the samples and the nozzle tips are arranged on a tray in pairs, and a dry analysis element necessary for measurement of a given sample is taken out from a cartridge selected according to measurement information separately input into the system.

In a biochemical analysis system disclosed in EP 0458138A2 (will be referred to as “the second biochemical analysis system”), a sample, an analysis element suitable for measurement of the sample and a nozzle tip are combined and contained in a cartridge as one set, and the cartridge is set to the system.

In a biochemical analysis system disclosed in Japanese Unexamined Patent Publication No. 11(1999)-237386 (will be referred to as “the third biochemical analysis system”), a sample, a mixing cup and a nozzle tip are combined and contained in a cartridge as one set, and the cartridge is set to the system separately from a dry analysis element.

In the first biochemical analysis system, since cartridges each containing therein lots of dry analysis elements are set to the system, a necessary dry analysis element can be used by only designating the kind of analysis element to be used. However, all dry analysis elements in a cartridge cannot be consumed within a limited period of service when the analysis elements in the cartridge are not used frequently. When some elements cannot be used within the period of service, the elements must be discarded, which is disadvantageous in view of the cost. Further inventory control with respect to consumption and the period of service is troublesome. Further, since the sample and the nozzle tip must be supplied one by one, the overall size of the system is enlarged.

In the second biochemical analysis system, the period of service of dry analysis elements causes no problem since the analysis element is used immediately after the cartridge is unsealed. However, the second biochemical analysis system is disadvantageous in that since only one nozzle tip is contained in one cartridge, samples which require dilution and accordingly require a plurality of nozzle tips cannot be handled. When the system is modified so that a plurality of nozzle tips can be mounted and different number of nozzle tips are mounted according to the kind of the sample to be analyzed, working load on the operator becomes too heavy and working efficiency deteriorates. Further, in the second system, the cartridge can use only small sample cups and it is impossible to mount a centrifuged blood-collecting tube.

In the third biochemical analysis system, though a blood-collecting tube can be mounted and a mixing cup can be mounted as a part of a set, only one set of a nozzle tip and a mixing cup for one sample can be mounted, which deteriorates the measuring efficiency. Further, since the dry analysis element is set separately from the cartridge, the dry analysis element can be mounted in a wrong combination with the sample.

In any of the first to third biochemical analysis systems, that a dry analysis element accurately corresponding to the measuring item of the sample can be mounted on the system without necessity of controlling consumption of the dry analysis elements and their period of service, that a plurality of samples can be set, that common consumables such as nozzle tips, mixing cups and the like can be set efficiently and that working load on the operator can be lightened are not well satisfied. At the same time, reduction of the size of the system has not been performed. Further, there has been a demand for a biochemical analysis system in which the order of measurement can be easily changed to deal with an emergency.

Further, biochemical analysis element cartridges employed in the conventional biochemical analysis systems involve the following problems.

That is, the dry analysis element has a reagent layer, and when the operator touches the reagent layer with his or her finger through a spotting hole through the reagent layer is exposed, the measured value can become abnormal. Accordingly, the dry analysis element must be carefully handled not to touch the reagent layer when unwrapping or carrying the element.

Further, in the conventional cartridge, the dry analysis elements are contained in a stack. Accordingly, opposite side walls of the cartridge casing are provided with vertical slits so that each dry analysis element can be introduced deep into the cartridge casing with its side edges held by fingers. That is, when the element is set in the cartridge casing, each element must be unwrapped, taken out with its one end held by fingers of one hand and set in the cartridge casing with its side edges held by fingers of the other hand. Since the number of the analysis elements consumed in the measurement are large, these procedures increase burden on the measurement.

The dry analysis element is apt to absorb moisture, which shorten its effective service life, after it is once unwrapped and depending on the kind of the dry analysis element, the dry analysis element can be affected within several tens of minutes after unwrapping. When there is a long time after setting the elements in the cartridge before each element is actually used for measurement, the measuring accuracy can deteriorate due to deterioration of the element. Accordingly, the number of the dry analysis elements to be set in one cartridge is inherently limited, which lowers the measuring efficiency.

In the cartridge where the dry analysis elements are held in the cartridge casing only under their gravities, the element transfer member sometimes fails to catch the element unless the dry analysis elements are pressed downward not to be lifted. Accordingly, in such a dry analysis element cartridge, a weight is generally put on the stack of the elements.

Accordingly, when new elements are stacked in the cartridge casing, the weight must be taken out and must be handled not to be stained and/or lost.

Further, depending on the kind of the dry analysis element, the dry analysis element can be deteriorated by external light. Accordingly, the dry analysis element must be protected from external light.

### SUMMARY OF THE INVENTION

In view of the foregoing observations and description, the primary object of the present invention is to provide a biochemical analysis system in which supply of a sample and a dry analysis element suitable for the measuring item of the sample can be efficiently effected for a plurality of samples, consumables such as the nozzle tips can be easily mounted without increasing the working load on the operator, the overall size of the system can be reduced and an emergency can be easily dealt with.

Another object of the present invention is to provide a biochemical analysis element which permits the dry analysis elements to be easily set in the cartridge casing and eliminates the necessity of weight.

In accordance with one aspect of the present invention, there is provided a biochemical analysis system comprising a circular sample tray in which a sample and a dry analysis element suitable for analyzing the sample are contained, a spotting nozzle unit which sucks the sample in the sample tray and spots the sample onto the dry analysis element, and an incubator which keeps the dry analysis element spotted with the sample at a constant temperature, wherein the improvement comprises that a plurality of sample cartridges each of which is a section of the sample tray in plan are removably mounted on the sample tray, and each of the sample cartridges is provided with a holding portion for holding a sample container containing therein a sample and a dry analysis element suitable for the item of measurement of the sample.

Preferably, consumables such as nozzle tips which are used in common in different items of measurement be contained in the sample tray separately from the sample cartridges. It is further preferred that the consumables be contained in a consumable cartridge which is removably mounted on the sample tray.

It is preferred that an element transfer member which takes out the dry analysis element from each of the sample cartridges be provided in a central portion of the circular sample tray.

With the biochemical analysis system of the present invention, a plurality of sample containers and a plurality of dry analysis elements necessary for measurement of the elements can be easily set to the system and management of the life of service becomes unnecessary, the overall size of the system can be reduced and a wrong combination of the sample and the dry analysis element can be prevented. Further since the sample cartridge can be easily removed from the system, the order of measurement can be easily changed, e.g., to deal with emergency. Further since setting of consumables such as nozzle tips in the sample cartridge is not necessary, the working burden on the operator can be reduced.

When consumables such as nozzle tips which are used in common in different items of measurement are contained in the sample tray separately from the sample cartridges, the overall size of the system can be further reduced, and the spotting nozzle drive mechanism and the sample tray drive mechanism can be simpler in structure. Especially, when the consumables are contained in a consumable cartridge which is removably mounted on the sample tray in the same manner as the sample tray, the nozzle tips and the mixing cups can be mounted on the sample tray together with each other, whereby the consumables can be easily replenished depending on the remainder and the working burden on the operator can be further reduced.

When the element transfer member which takes out the dry analysis element from each of the sample cartridges is provided in a central portion of the circular sample tray, the overall size of the system can be reduced, the system can be simpler in mechanism, and the dry analysis element can be transferred without interference with the sample container.

In accordance with another aspect of the present invention, there is provided a biochemical analysis element cartridge which contains a plurality of dry analysis elements in a stack and supplies dry analysis elements necessary for measurement to a biochemical analysis system one by one, the biochemical analysis element cartridge comprising a cartridge casing having an element chamber provided at one end thereof with an element take-out port through which the biochemical analysis element can be inserted into and taken out from the element chamber and at the other end thereof with an element transfer member insertion port through which an element transfer member for pushing out the biochemical analysis element through the element take-out port can be inserted into the element chamber, wherein the improvement comprises that

a pressing member which urges the stack of the dry analysis elements toward the element take-out port is provided in the element chamber, and

the element take-out port is provided a guide surface which permits virgin dry analysis elements to be inserted into the element chamber moving the pressing member away from the element take-out port.

It is preferred that the element chamber be provided with a drying agent insertion opening which is formed to open in the element chamber behind the pressing member and is opened and closed by a lid and drying agent is introduced into the element chamber through the drying agent insertion opening. In this case, it is further preferred that the pressing member breaks communication between the interior of the element chamber and the exterior of the same when there is no dry analysis element in the element chamber.

Further, it is preferred that the cartridge casing and the pressing member be formed of light-shielding material and the lid be formed of transparent material.

It is further preferred that the biochemical analysis element cartridge further comprises a sample holding portion for holding a sample container.

With the biochemical analysis element cartridge of the present invention, the dry analysis element can be set in the cartridge casing without shifting the element from one hand to the other, the working burden on the operator can be reduced especially when the number of the elements is large.

Further the pressing member eliminates the necessity of putting a weight on the stack of the analysis elements, and accordingly, setting of dry analysis elements in the cartridge casing is facilitated and the problem that stain of the weight affects the measured value and the weight can be lost.

When drying agent is introduced into the element chamber, the element chamber can be kept low in humidity, whereby deterioration of the element after unwrapping can be suppressed and the effective service life can be elongated. Accordingly, a plurality of samples and a plurality of dry analysis elements can be set in the biochemical analysis system and the measuring efficiency can be improved.

When the pressing member breaks communication between the interior of the element chamber and the exterior of the same when there is no dry analysis element in the element chamber, deterioration of the drying agent in an unused state of the system can be prevented. After the dry analysis elements are inserted into the element chamber, the spotting hole of each element through which the reagent layer is exposed is closed by another analysis element or the pressing member, whereby the reagent layer can be protected from the moisture in the atmosphere. The drying agent can be replaced through the drying agent insertion opening.

When the cartridge casing and the pressing member are formed of light-shielding material and the lid is formed of transparent material, deterioration of the analysis element by external light can be prevented while, for instance, change in color of the drying agent which represents the current humidity pickup can be viewed from outside the system.

When the biochemical analysis element cartridge further comprises a sample holding portion for holding a sample container, a sample and a dry analysis element necessary for measurement of the sample can be easily set in a cartridge, whereby wrong combination of the sample and the analysis element can be prevented.

### BRIEF DESCRIPTION OF THE DRAWINGS

FIG. 1 is a perspective view showing a biochemical analysis system in accordance with an embodiment of the present invention,

FIG. 2 is a plan view showing a modification of the biochemical analysis system shown in FIG. 1,

FIG. 3 is a perspective view showing the sample cartridge,

FIG. 4 is a perspective view showing another example of the sample cartridge,

FIG. 5 is a cross-sectional view of the sample cartridge shown in FIG. 4, and

FIGS. 6A and 6B are cross-sectional views for illustrating manner of setting the dry analysis elements in the sample cartridge shown in FIG. 4.

### DESCRIPTION OF THE PREFERRED EMBODIMENT

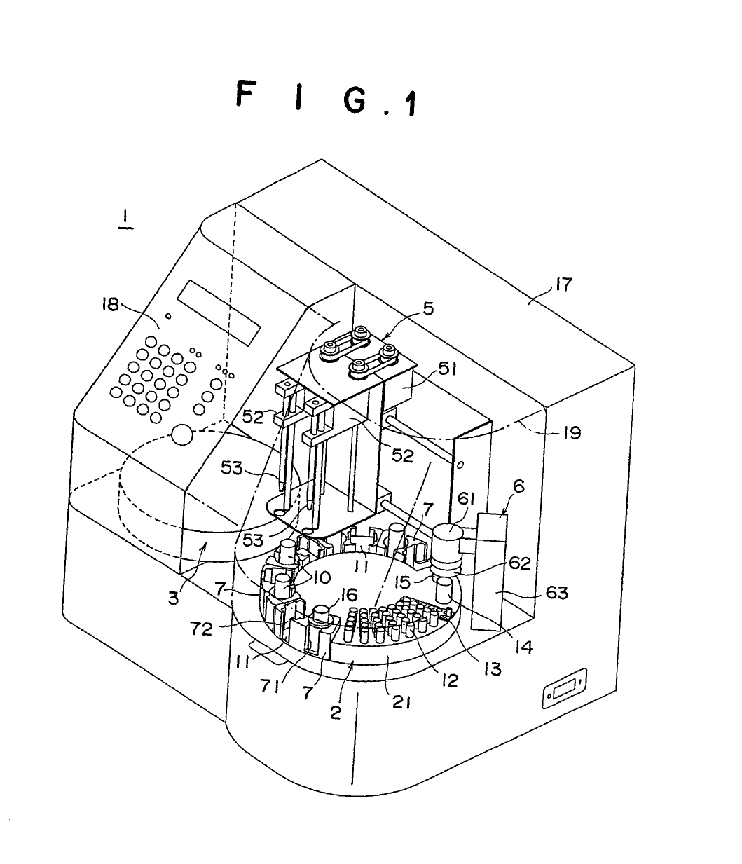

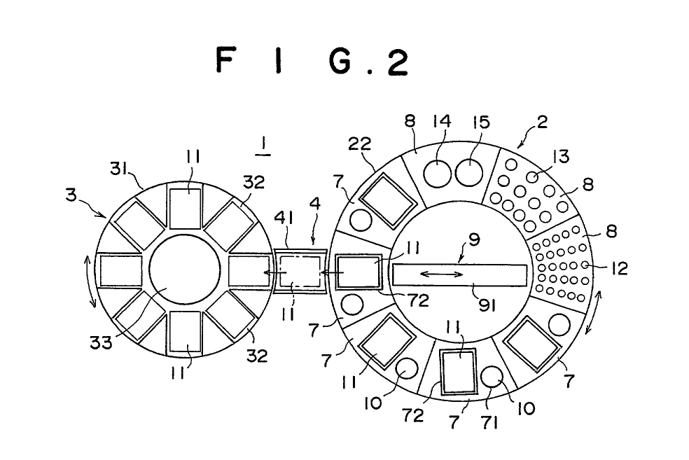

In FIG. 1, a biochemical analysis system 1 in accordance with an embodiment of the present invention comprises a system body 17 and a circular sample tray 2 is provided on one side of the front portion of the system body 17. An incubator 3 is provided on the other side of the front portion of the system body 17, and a spotting station 4 (FIG. 2) is provided between the sample tray 2 and the incubator 3. Further a spotting nozzle unit 5 is provided on an upper portion of the system body 17 to be movable right and left. A blood filtering unit 6 for separating blood plasma from blood is provided beside the sample tray 2.

The sample tray 2 comprises a disc-like turntable 21 which is rotated in opposite directions. The turntable 21 is has an arcuate recess on the upper surface thereof along the outer periphery thereof, and five sample cartridges 7 each of which is a sector in cross-section are mounted in the arcuate recess. The sample cartridges 7 are removable separately from each other. As will be described in more detail later, each sample cartridge 7 comprises a sample holding portion 71 which holds a sample container 10 holding therein a sample, and an analysis element holding portion 72 which holds a stack of virgin dry analysis elements 11 (colorimetric dry analysis elements or electrolytic dry analysis elements) of different types. Generally a plurality of kinds of dry analysis elements are used for each measuring item.

Consumables are held on the other part of the upper surface of the turntable 21 along the outer periphery. That is, a number of nozzle tips 21 are held in a nozzle tip holding holes formed on a first arcuate portion along the outer periphery of the turntable 21, a mixing cup 13 (a molded product provided with a plurality of cup-like recesses) is held on a second arcuate portion, and a diluent container 14 and a reference liquid container 15 are held in holding recesses formed on a third arcuate portion along the outer periphery of the turntable 21.

That is, in the sample tray 2, a plurality of sample cartridges 7 each containing one sample container (e.g., a blood-collecting tube) 10 and dry analysis elements 11 necessary for analysis of the sample are set in the sample tray 2 together with a number of nozzle tips 12 and the mixing cups 13 (as the consumables used commonly in different measurements), and the diluent containers 14 and the reference liquid containers 15.

The consumables may be set in the form of cartridges as shown in FIG. 2.

FIG. 2 shows a modification of the sample tray 2. In FIG. 2, the sample tray 2 of this modification comprises a disc-like turntable 22 which is rotated in opposite directions. Five sample cartridges 7 and three consumable cartridges 8 are mounted on the turntable 22 in a circle. That is, each of the cartridges 7 and 8 forms a part of a sector whose interior angle is 45° (360/8) and eight cartridges form a circle. All the cartridges 7 and 8 are of the same shape and each cartridge can be removed independently.

Each sample cartridge 7 comprises a sample holding portion 71 which holds a sample container 10 holding therein a sample, and an analysis element holding portion 72 which holds a stack of virgin dry analysis elements 11 of different types. One of the three consumable cartridges 8 holds a number of nozzle tips 12, another consumable cartridge 8 holds a number of mixing cups 13 and the other consumable cartridge 8 holds a diluent container 14 and a reference liquid container 15. Each of the consumable cartridge 8 is provided with suitable recesses. When the sample cartridges 7 and the consumable cartridges 8 are mounted on the sample tray 2, a plurality of a sample containers 10 and a plurality of dry analysis elements 11 necessary for analysis of the samples are set in the sample tray 2 together with a number of nozzle tips 12 and mixing cups 13 and the diluent container 14 and the reference liquid container 15 as in the sample tray 2 shown in FIG. 1.

The turntable 21 (or 22) of the sample tray 2 is rotated in the regular direction or the reverse direction by a drive mechanism (not shown) to positions where the spotting nozzle unit 5 operates. By controlling the angular position of the turntable and the position of the spotting nozzle unit 5, predetermined operations required to spotting the sample on the analysis element such as mounting a nozzle tip 12, sucking a sample, diluent or the reference liquid, and mixing the sample and the diluent are carried out.

An element transfer means 9 (FIG. 2) which transfers the dry analysis element 11 is provided at the central portion of the sample tray 2. The element transfer means 9 comprises an element transfer member 91 (an insertion lever) which is slid back and forth in a radial direction of the sample tray 2 by a drive mechanism (not shown). The element transfer means 9 causes the element transfer member 91 to push a dry analysis element 11 out of a sample cartridge 7 into the spotting station 4, to push the element 11 spotted with the sample into the incubator 3, and to further push the element 11 toward the center of the incubator 3 after measurement to discard the element 11. The element transfer means 9 controls the drive mechanism for the turntable 21 (22) to bring the sample cartridges 7 to the spotting station 4 in sequence.

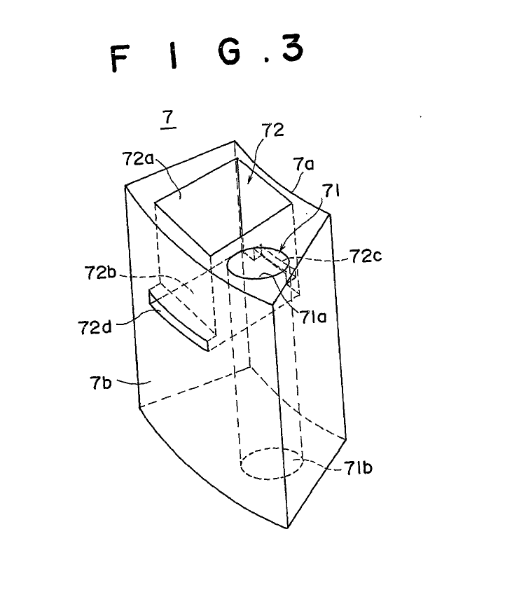

As shown in FIG. 3, the sample cartridge 7 is a sector in plan (the top surface and the bottom surface are sectorial) obtained by dividing the sample tray 2 by straight lines passing through the center of the sample tray 2. That is, the inner and outer end faces 7a and 7b are arcuate and right and left side faces are oblique faces directed toward the center of the sample tray 2.

As described above, the sample cartridge 7 comprises a sample holding portion 71 which holds a sample container 10 holding therein a sample, and an analysis element holding portion 72 which holds a stack of dry analysis elements 11.

The analysis element holding portion 72 is in the form of a rectangular recess extending downward from an element setting opening 72a formed in the top surface of the cartridge 7 to a bottom 72b at a predetermined depth from the top surface of the cartridge 7. A transfer member insertion port 72c opens in the inner end face 7a in a position opposed to the lowermost dry analysis element 11 so that the element transfer member 91 is inserted into the analysis element holding portion 72 through the port 72c, and an element take-out port 72d is formed in the outer end face 7b of the cartridge 7 so that the lowermost element 11 is pushed out through the element take-out port 72d by the transfer member 91 inserted into the analysis element holding portion 72 through the port 72c. The lowermost element 11 is pushed toward the spotting station 4. It is preferred that a weight is placed on the stack of the dry analysis elements 11 so that the stack of the dry analysis elements 11 is pressed downward and the elements 11 can be pushed out surely one by one.

The transfer member insertion port 72c is smaller in width than the dry analysis elements 11 so that the lowermost element 11 does not escape through the insertion port 72c. Further, the height of the element take-out port 72d is smaller than double of the thickness of the elements 11 so that only one element 11 can be pushed out at one time. The element transfer member 91 can be moved forward through the element take-out port 72d to further move the element 11.

The sample holding portion 71 is in the form of a cylindrical recess extending downward from an sample introduction opening 71a formed in the top surface of the cartridge 7 to a bottom 71b at a predetermined depth from the top surface of the cartridge 7. A sample container 10 is inserted into the sample holding portion 71. The sample holding portion 71 is formed beside the analysis element holding portion 72 near the outer end face 7b of the cartridge where a maximum space is obtained since the width of the cartridge 7 becomes larger from the inner end face 7a thereof. With this arrangement, a relatively large sample container 10 such as a blood-collecting tube can be easily set in the sample holding portion 71 without interference with the element transfer member 91, and the space can be effectively utilized, whereby the sample tray 2 can be small in size.

In the sample cartridge 7 shown in FIG. 1, the element holding portion 72 is provided with vertical slits formed in the inner end face 7a and the outer end face 7b. With this arrangement, the dry analysis element 11 can be inserted deep into the element holding portion 72 through the element setting opening 72a with opposite edges of the element 11 held by fingers. Also the sample holding portion 71 is provided with similar vertical slits formed in the inner end face 7a and the outer end face 7b.

When plasma of the sample is to be filtered, a holder 16 with a filter is mounted on the sample container 10 set in the sample cartridge 7 as shown in FIG. 1.

The sample cartridge 7 may be in other forms. For example, a pressing member urged downward may be slidably inserted into the element holding portion 72 with drying agent disposed above the pressing member and with the upper part of the element holding portion 72 closed with a lid so that the dry analysis elements 11 are obliquely forced into the element holding portion 72 through the element take-out port 72d.

The sample cartridges 7 can be freely set on the turntable 21 (or 22) and can be freely exchanged before measurement. Accordingly, the order of measurement can be easily changed to deal with an emergency. Further, each sample cartridge 7 is provided with an identification member, and setting of the sample cartridge 7 to the sample tray 2 is detected by the identification member and the kind of the sample and/or whether the sample is to be filtered can be distinguished on the basis of the identification member. The consumable cartridge 8, which is of the same shape as the sample cartridge 7, can be replaced by a new consumable cartridge filled with consumables when the amount of consumables left in the cartridge becomes small.

The dry analysis element 11 to be set in the sample cartridge 7 will be described, hereinbelow. The colorimetric dry analysis element 11 for measuring coloring of the sample generally comprises a square mount and a reagent layer provided in the mount. A spotting hole is formed on the surface of the mount and the sample is spotted in the spotting hole. The electrolytic dry analysis element 11 for measuring the activity of a specific ion in the sample is provided with a pair of spotting holes and the sample liquid is spotted in one of the spotting holes while reference liquid whose ion activity has been known is spotted in the other spotting hole. Further, the electrolytic dry analysis element 11 for measuring the activity of a specific ion in the sample is provided with three ion selective electrode pairs which are electrically connected to probes for measuring the potential difference. The dry analysis element 11 is provided with bar codes (not shown) representing information on the item to be analyzed.

The spotting station 4 (FIG. 2) is for spotting a sample such as plasma, whole blood, serum, urine or the like on the dry analysis element 11. At the spotting station 4, in the case of a colorimetric dry analysis element 11, a sample is spotted on the element 11 by the spotting nozzle unit 5 and in the case of an electrolytic dry analysis element 11, a sample and reference liquid are spotted on the element 11 by the spotting nozzle unit 5.

At the spotting station 4, there are provided an element support table 41 on which the dry analysis element 11 is placed and an element holding member (not shown) with a spotting opening through which the sample and/or the reference liquid is spotted. The dry analysis element 11 is moved between the element support table 41 and the element holding member. Though not shown, a bar code reader for reading the bar code on the element 11 is provided on the upstream side of the spotting station 4. The bar code reader is for identifying the item of measurement and controlling the subsequent spotting and measurement, and for detecting the position of the element 11 (whether the element 11 is upside down or in a wrong direction).

The spotting nozzle unit 5 (FIG. 1) comprises a horizontal movement block 51 which is movable in a horizontal direction and a pair of vertical movement blocks 52 which are movable up and down on the horizontal movement block 51. A spotting nozzle 52 is fixed on each of the vertical movement block 52. The horizontal movement block 51 and the vertical movement blocks 52 are moved in the respective direction by drive means (not shown) The spotting nozzles 53 are integrally moved right and left and are moved up and down independently of each other. For example, one of the spotting nozzles 53 is for spotting the sample, and the other is for spotting the diluent or the reference liquid.

The spotting nozzle 53 is in the form of a rod provided with an air passage extending in the axial direction and a pipette-like nozzle tip 12 is fitted on the lower end portion thereof. The spotting nozzles 53 are connected to air tubes respectively connected to syringe pumps (not shown), and a suction force and a discharge force are selectively supplied to the spotting nozzles 53. After measurement, the used nozzle tips 12 are removed from the spotting nozzles 53 and discarded.

The incubator 3 comprises a disc-like rotary member 31 which is driven by a drive mechanism (not shown) and is provided with a plurality of element chambers 32 which are arranged along its circumference and in which the dry analysis elements 11 are inserted. The element chamber 32 are brought into alignment with the spotting station in sequence as the rotary member 31 is rotated. An upper member (not shown) is provided above the rotary member 31. The bottom surface of each element chamber 32 is flush with the upper surface of the element support table 41 and the dry analysis element 11 can be inserted into the chamber 32 from the spotting station 4 by simply pushing the element 11. In the element chamber 32, the element 11 spotted with the sample is kept at a constant temperature (incubated) by virtue of a heater provided on the upper member.

Further, the rotary member 31 is provided with a discarding hole 33 at the center thereof, and after measurement, the dry analysis element 11 is dropped into a discarding box disposed below the discarding hole 33. The incubator 3 is provided with a cover which closes the upper side thereof.

The incubator 3 is further provided with a measuring means (not shown). Since both a calorimetric dry analysis element and an electrolytic dry analysis element can be transferred to the incubator 3, the measuring means can carried out both the colorimetric measurement and the potential difference measurement. It is possible to provide first and second incubators so that one of the incubators is provided with a measuring means for carrying out the calorimetric measurement and the other incubator is provided with a measuring means for carrying out the potential difference measurement.

When the calorimetric measurement is to be carried out, a measuring window is formed through the central portion of each element chamber 32 and the reflective optical density of the dry analysis element 11 is measured through the measuring window by a light measuring head of the measuring means. The rotary member 31 of the incubator 3 is rotated to bring the element chambers 32 to a measuring position in sequence and the optical density due to the coloring reaction is measured for each element 11. Thereafter the rotary member 31 is reversed to return the element chambers 32 to the initial position.

When the ion activity is to be measured, three pairs of holes are formed in the side wall of each element chamber 32 so that three pairs of probes for measuring the potential difference can be brought into contact with the ion selective electrodes of the electrolytic dry analysis element 11. When the sample liquid is spotted in one of the spotting holes while reference liquid is spotted in the other spotting hole, a potential difference corresponding to the difference in ion activity between the sample and the reference liquid is produced between the ion selective electrode pair. By detecting the potential differences between the ion selective electrode pairs, the activities of the respective ions in the sample can be measured.

The blood filtering unit 6 is inserted into the sample container 10 held in the sample tray 2 and sucks plasma through the holder 16 with a glass fiber filter which is mounted on the upper end of the sample container 10, thereby separating plasma from the blood and holding the separated plasma in a cup formed on the top of the holder 16. The blood filtering unit 6 comprises a sucking mechanism 61 which supplies suction force, and a suction pad 62 which is connected to a suction pump (not shown) and attracts the holder 16 under a suction force is provided on the lower end of the sucking mechanism 61. The sucking mechanism 61 is mounted on a support post 63 to be moved up and down by a drive mechanism (not shown).

When the plasma is separated from the blood, the sucking mechanism 61 is moved downward to be brought into a close contact with the holder 16. In this state, the suction pump is operated to suck the whole blood in the sample container 10, whereby the plasma separated from the blood is introduced into the cup formed on the top of the holder 16. Thereafter, the sucking mechanism 61 is returned to the initial position.

In FIG. 1, a control panel 18 is provided above the incubator 3. The sample tray 2 and the spotting nozzle unit 5 are covered with a transparent protective lid 19 which is openable. The sample cartridges 7 are set or changed with the lid 19 opened.

Operation of the biochemical analysis system of this embodiment will be described, hereinbelow. A sample container 10 and one or more unsealed dry analysis elements 11 suitable for the item of measurement are set in a sample cartridge 7 outside the system body 17. Then the lid 19 is opened and the sample cartridge 7 is set in the sample tray 2. When a plurality of samples are to be measured, a plurality of suitable sample cartridges 7 are set in the sample tray 2. Further consumables such as the nozzle tips 12, the mixing cups 13, the diluent containers 14 and the reference liquid containers 15 are set in the sample tray 2. When the sample tray 2 is as shown in FIG. 2, the consumable cartridges 8 are set in the sample tray 2.

Then analysis is started. In case of emergency, analysis is interrupted and the sample cartridge 7 to be analyzed urgently is set in a vacant space or in place of another sample cartridge.

Blood plasma is first separated from the whole blood in the sample container 10 by the blood filtering unit 6. Then the sample tray 2 is rotated to bring the sample cartridge 7 containing therein a sample to be analyzed to the spotting station 4. Then one of the dry analysis elements 11 in the sample cartridge 7 is transferred to the spotting station 4 by the element transfer member 91 of the transfer means 9. On the way to the spotting station 4, the bar code on the element 11 is read by the bar code reader and the item of analysis and the like are detected. When the item of analysis represented by the bar code is ion activity measurement, processing differs according to the instruction on dilution and the like.

When the item of analysis represented by the bar code is colorimetry, the sample tray 2 is rotated to bring a nozzle tip 12 below the spotting nozzle 53 and the nozzle tip 12 is mounted on the spotting nozzle 53. Then the sample container 10 is moved and the spotting nozzle 53 is moved downward to dip the nozzle tip 12 into the sample and to cause the nozzle tip 12 to suck the sample. Thereafter the spotting nozzle 53 is moved to the spotting station 4 and spots the sample onto the dry analysis element 11 at the spotting station 4.

Then the dry analysis element 11 spotted with the sample is inserted into the incubator 3. Thereafter, the rotary member 31 of the incubator 3 is rotated to bring the element chambers 32 to the measuring position in sequence where the dry analysis element in the chamber 32 is opposed to the light measuring head and the reflective optical density of the element 11 is measured by the light measuring head. After the measurement, the rotary member 31 is rotated to return the chamber 32 to the spotting position and the dry analysis element 11 is pushed toward the center by the element transfer member 91 to be discarded. The result of the measurement is output and the used nozzle tip 12 is removed from the spotting nozzle 53. Then processing is ended.

When the sample is to be diluted, e.g., when the blood is too thick to carry out accurate measurement, the sample tray 2 is moved to bring the nozzle tip 12 holding the sample to a mixing cup 13. Then the spotting nozzle 53 discharges the sample held by the nozzle tip 12 into the mixing cup 13. Then the used nozzle tip 12 is removed from the spotting nozzle 53, and a new nozzle tip 12 is mounted on the spotting nozzle 53. The spotting nozzle 53 causes the nozzle tip 12 to suck the diluent from the diluent container 14 and to discharge the diluent into the mixing cup 13. Thereafter the spotting nozzle 53 dips the nozzle tip 12 into the mixing cup and causes the nozzle tip 12 to repeat suck and discharge, thereby stirring the mixture in the mixing cup 13. Then the spotting nozzle 53 causes the nozzle tip 12 to suck the diluted sample and moves the nozzle tip 12 to the spotting station 4. At the spotting station 4, the spotting nozzle 53 causes the nozzle tip 12 to spot the diluted sample onto the dry analysis element 11. Then the aforesaid, light measuring step, element discarding step and result outputting step follow.

When the item of analysis represented by the bar code is ion activity measurement, an electrolytic dry analysis element 11 is transferred to the spotting station 4 and the nozzle tips 12 mounted on the respective spotting nozzles 53 are caused to suck the sample in the sample container 10 and the reference liquid in the reference liquid container 15. Thereafter, the sample liquid is spotted in one of the spotting holes and the reference liquid is spotted in the other spotting hole.

The electrolytic dry analysis element 11 spotted with the sample and the reference liquid is inserted into one of the element chambers 32 of the incubator 3. Then ion activity is measured by a potential difference measuring means. After the measurement the dry analysis element 11 is discarded, the result of the measurement is output and the used nozzle tips 12 are removed from the respective spotting nozzles 53. Then processing is ended.

In the biochemical analysis system of the embodiment described above, a plurality of sample cartridges 7 each containing therein a sample container 10 and a dry analysis element 11 necessary for measurement of the sample are mounted on the sample tray 2 as well as the consumables such as nozzle tips 12 and the mixing cups 13, and accordingly, a plurality of samples can be easily set to the system in correct combination with dry analysis elements suitable for measurement of the samples. Further since elements 11 are set in the cartridge 7 immediately after unwrapping, all the elements 11 can be consumed in the period of service, whereby no element 11 need not be discarded. Further since the sample cartridge 7 can be easily removed from the system, the order of measurement can be easily changed, e.g., to deal with emergency. Further operation of the operator is facilitated and measuring efficiency can be increased without increasing the overall size of the system.

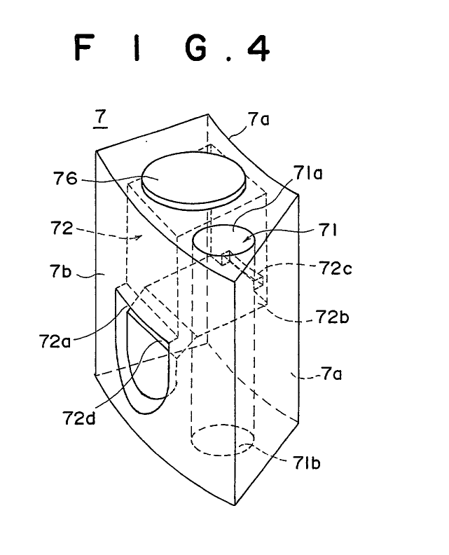

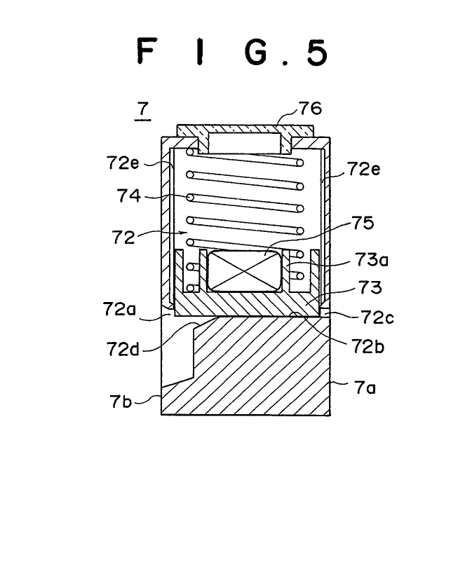

A preferred example of the sample cartridge will be described with reference to FIGS. 4, 5, 6A and 6B, hereinbelow.

As shown in FIGS. 4, 5, 6A and 6B, the sample cartridge 7 is a sector in plan (the top surface and the bottom surface are sectorial) obtained by dividing the sample tray 2 by straight lines passing through the center of the sample tray 2. That is, the inner and outer end faces 7a and 7b are arcuate and right and left side faces are oblique faces directed toward the center of the sample tray 2. The sample cartridge 7 comprises a sample holding portion 71 which holds a sample container 10 holding therein a sample, and an analysis element holding chamber 72 which holds a stack of dry analysis elements 11.

The analysis element holding chamber 72 is in the form of a rectangular chamber extending downward from the top surface of the cartridge 7 to a bottom 72b at a predetermined depth from the top surface of the cartridge 7. A transfer member insertion port 72c opens in the inner end face 7a in a position opposed to the lowermost dry analysis element 11 so that the element transfer member 91 is inserted into the analysis element holding chamber 72 through the port 72c, and an element take-out port 72a is formed in the outer end face 7b of the cartridge 7 so that the lowermost element 11 is pushed out through the element take-out port 72a by the transfer member 91 inserted into the analysis element holding chamber 72 through the port 72c.

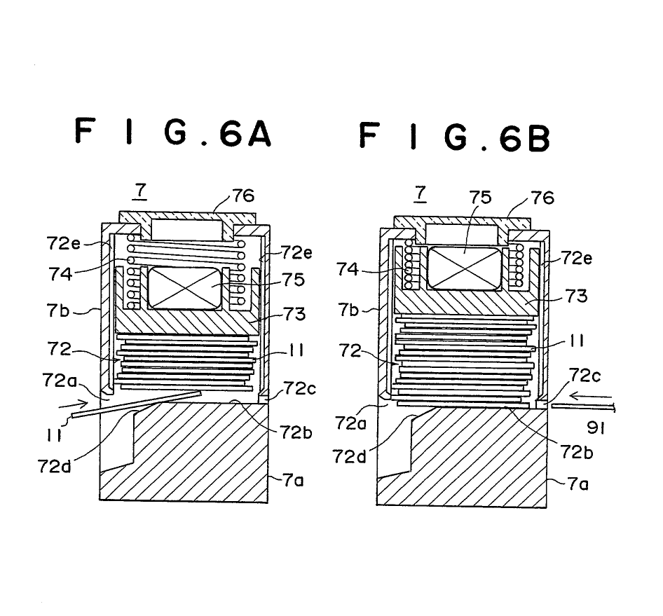

The dry analysis elements 11 are also set in the analysis holding chamber 72 through the element take-out port 72a. The height of the element take-out port 72a is smaller than double of the thickness of the elements 11 with respect to the bottom 72b of the element holding chamber 72 so that only one element 11 can be pushed out at one time. The portion below the element take-out port 72a is recessed wide and an inclined guide surface 72d is formed toward the bottom 72b of the element holding chamber 72. When an unused dry chemical analysis element 11 is inserted into the element holding chamber 72 through the element take-out port 72a from below the same, the unused dry analysis element 11 is moved along the guide surface 72d and is positioned in the lowermost position in the element holding chamber 72 pushing upward a pressing member 73 to be described later as shown in FIG. 6A.

In this manner, a required number of dry analysis elements 11 are inserted into the element holding chamber 72 through the element take-out port 72a and are stacked in the element holding chamber 72 as shown in FIG. 6B. The element transfer member 91 inserted through the transfer member insertion port 72c is moved forward to push the lowermost element 11 through the element take-out port 72a toward the spotting station 4.

The transfer member insertion port 72c is smaller in width than the dry analysis elements 11 so that the lowermost element 11 does not escape through the insertion port 72c. The element transfer member 91 can be moved forward through the element take-out port 72a to further move the element 11.

A pressing member 73 (not shown in FIG. 4) is provided inside the element holding chamber 72 to urge the stack of the dry analysis elements 11 toward the bottom 72b of the element holding chamber 72 (toward the element take-out port 72a) so that the lowermost element 11 can be surely ejected by the element transfer member 91. The pressing member 73 is of the same shape in plan as the cross-section of the element holding chamber 72 and is held in the chamber 72 for up and down movement. Further, the pressing member 73 is urged downward by a compression spring 74 provided above the pressing member 73. A partition wall 73a is provided on the upper surface of the pressing member 73 to form a recess, in which drying agent 75 is received. The drying agent 75 is inserted into the recess through an opening which is formed in the top wall of the element holding chamber 72 and is closed by a lid 76. Vertical grooves 72e are formed on the inner surface of the element holding chamber 72 to communicate the spaces on the upper and lower sides of the pressing member 73 so that the space on the lower side of the pressing member 73 can also be dehumidified by the drying agent 75.

The lower ends of the vertical grooves 72e do not reach the element take-out port 72a nor the transfer member insertion port 72c so that when there remains no dry analysis element 11 in the element holding chamber 72, the pressing member 73 air-tightly closes the element take-out port 72a and the transfer member insertion port 72c so that the interior of the element holding chamber 72 does not communicate with the exterior of the same, thereby preventing the drying agent 75 from absorbing moisture in the exterior to deteriorate while it is not operating. In the state shown in FIG. 6B where the dry analysis elements 11 are stacked, the spotting hole of each element 11 through which the reagent layer is exposed is closed by another analysis element 11 or the pressing member 73, whereby the reagent layer can be protected from the moisture in the atmosphere.

When the casing of the cartridge 7 and the pressing member 73 are formed of light-shielding material and the lid 76 is formed of transparent material, deterioration of the analysis elements 11 by external light can be prevented while, for instance, change in color of the drying agent 76 which represents the current humidity pickup can be viewed from outside the system.

The sample holding portion 71 is in the form of a cylindrical recess extending downward from an sample introduction opening 71a formed in the top surface of the cartridge 7 to a bottom 71b at a predetermined depth from the top surface of the cartridge 7. A sample container 10 such as a blood collecting tube is inserted into the sample holding portion 71. The sample holding portion 71 is formed beside the analysis element holding portion 72 near the outer end face 7b of the cartridge where a maximum space is obtained since the width of the cartridge 7 becomes larger from the inner end face 7a thereof. With this arrangement, a relatively large sample container 10 such as a blood-collecting tube can be easily set in the sample holding portion 71 without interference with the element transfer member 91, and the space can be effectively utilized, whereby the sample tray 2 can be small in size.

For example, the cartridge casing is molded in two pieces, a lower piece including a lower half of the element chamber 72 and an upper piece including an upper half of the element chamber 72. After molding the lower and upper pieces, the pressing member 72 and the spring 74 are set in the element chamber 72 in the lower piece and the upper piece is welded on the lower piece.

Though, in the preferred example of the sample cartridge described above, the guide surface 72d is an inclined straight surface, the guide surface 72d need not be limited to such an inclined straight surface. For example, it may be an arcuate surface.

In the preferred example of the sample cartridge 7, since the dry analysis elements 11 are set in the element chamber 72 through the element take-out port and the pressing member 73 eliminates the necessity of a weight, the dry analysis elements 11 can be easily and surely set in the cartridge 7. Further, by virtue of the drying agent 75 introduced into the element chamber 72, the element chamber 72 can be kept low in humidity, whereby deterioration of the element 11 after unwrapping can be suppressed and the effective service life can be elongated. Accordingly, a plurality of samples and a plurality of dry analysis elements 11 can be set in the biochemical analysis system and the measuring efficiency can be improved. Further, by mounting a plurality of sample cartridges 7 each containing therein a sample container 10 and dry analysis elements necessary for measurement of the sample on the sample tray 2, a plurality of kinds of sample and dry analysis elements 11 are set in the biochemical analysis system surely and easily in correct combinations.

What is claimed is:

1. A biochemical analysis system comprising a circular sample tray in which a sample and a dry analysis element suitable for analyzing the sample are contained, a spotting nozzle unit which sucks the sample in the sample tray and spots the sample onto the dry analysis element, and an incubator which keeps the dry analysis element spotted with the sample at a constant temperature, wherein the improvement comprises that
a plurality of sample cartridges each of which is a section of the sample tray in plan are removably mounted on the sample tray, and each of the sample cartridges is provided with a holding portion for holding a sample container containing therein a sample and a dry analysis element suitable for the item of measurement of the sample.

2. A biochemical analysis system as defined in claim 1 in which consumables such as nozzle tips which are used in common in different items of measurement are contained in the sample tray separately from the sample cartridges.

3. A biochemical analysis system as defined in claim 2 in which the consumables are contained in a consumable cartridge which is removably mounted on the sample tray.

4. A biochemical analysis system as defined in claim 1 in which an element transfer member which takes out the dry analysis element from each of the sample cartridges is provided in a central portion of the circular sample tray.

5. A biochemical analysis element cartridge which contains a plurality of dry analysis elements in a stack and supplies dry analysis elements necessary for measurement to a biochemical analysis system one by one, the biochemical analysis element cartridge comprising a cartridge casing having an element chamber provided at one end thereof with an element take-out port through which the biochemical analysis element can be inserted into and taken out from the element chamber and at the other end thereof with an element transfer member insertion port through which an element transfer member for pushing out the biochemical analysis element through the element take-out port can be inserted into the element chamber, wherein the improvement comprises that
a pressing member which urges the stack of the dry analysis elements toward the element take-out port is provided in the element chamber, and
the element take-out port is provided a guide surface which permits virgin dry analysis elements to be inserted into the element chamber moving the pressing member away from the element take-out port.

6. A biochemical analysis element cartridge as defined in claim 5 in which the element chamber is provided with a drying agent insertion opening which is formed to open in the element chamber behind the pressing member and is opened and closed by a lid and drying agent is introduced into the element chamber through the drying agent insertion opening.

7. A biochemical analysis element cartridge as defined in claim 6 in which the cartridge casing and the pressing member are formed of light-shielding material and the lid is formed of transparent material.

8. A biochemical analysis element cartridge as defined in claim 5 further comprising a sample holding portion for holding a sample container.
